(19) United States
(12) Patent Application Publication
(10) Pub. No.: US 2025/0383382 A1
(43) Pub. Date: Dec. 18, 2025

(54) NATURAL LANGUAGE INTERACTIVE ELECTRIC METERING PLATFORM

(71) Applicant: Utilidata, Inc., Providence, RI (US)

(72) Inventors: Marissa Hummon, Golden, CO (US); Michael James, Northville, MI (US); Taylor Spalt, Sterling, VA (US)

(73) Assignee: Utilidata, Inc., Providence, RI (US)

(21) Appl. No.: 19/013,401

(22) Filed: Jan. 8, 2025

Related U.S. Application Data
(60) Provisional application No. 63/659,699, filed on Jun. 13, 2024.

(51) Int. Cl. G01R 22/06; H04L 9/40

(52) U.S. Cl. CPC G01R 22/063; H04L 63/10

(57) ABSTRACT

Technical solutions provide a system with a device having a processor coupled with memory to receive, via an interface, a query related to a characteristic of electricity and retrieve data for the grid edge device. The data can include any combination of contextual data, operational data and metering data related to the device or the site. The device can construct a prompt data structure using generative artificial intelligence based on the input query and the data for the device. The device can generate, using the generative artificial intelligence on the device, code responsive to the prompt data structure. The device can execute the processor-executable code to generate output responsive to the query and perform an action in accordance with the output.

### CROSS-REFERENCES TO RELATED APPLICATIONS

This application claims the benefit of priority under 35 U.S.C. § 119 to U.S. Provisional Patent Application No. 63/659,699, filed Jun. 13, 2024, which is hereby incorporated by reference herein in its entirety.

### FIELD OF THE DISCLOSURE

This disclosure relates generally to systems and methods of a natural-language-interactive electric-metering platform, including, for example, executing a natural language model (NLM) for edge device operation.

### BACKGROUND

Utility distribution grids can generate and distribute electric power to various customer sites. The utility distribution grids can supply power via transmission or distribution lines to various loads at the customer sites, such as consumer electric devices or residential charging infrastructures.

### BRIEF SUMMARY OF THE DISCLOSURE

The utility distribution grids can use meters to observe or measure utility delivery or consumption in the grid. These meters, among other components within utility distribution grids, can collect samples of power delivery to or consumption at respective sites (e.g., residential homes, facilities, or entities), such as voltage information, at a sample rate (e.g., one sample every 15 to 60 minutes). Loads may be fed from diverse energy sources, e.g., gasoline, propane, oil, wood, natural gas, or electricity. In some cases, the loads may be unified under a single energy source (e.g., electricity) from the electrification of these loads, which introduces challenges for electric utilities, including support for the increased current flows.

In certain systems, a non-physical approach may be implemented, such as modulating flexible or controllable loads via pricing to discourage electrical usage at peak times or charging and discharging energy storage at the edge during off-peak times and peak times, respectively. The non-physical approach may involve a tradeoff, such as the extended utilization of existing, physical grid infrastructure at the expense of complexifying its end-to-end operation. The increase in complexity may demand more actions to be taken by the consumers to be effective and take advantage of these opportunities to improve energy efficiency and operation efficiency. Accordingly, it can be beneficial for grid-based systems to include functionalities to receive input queries from client devices and provide outputs and take actions to adjust grid-based system operation based on the input queries, thereby facilitating improvement of energy efficiency of the system.

To overcome these challenges, the technical solutions of this disclosure can be configured to measure power consumption and generation at the grid edge and process the data to assist the consumers as discussed herein. For instance, systems and methods can provide benefits to the consumers, in at least the categories of reliability, billing, and optimization of flexible or controllable loads and distributed energy resources (DERs). Each category may include topics of interest to the consumers, in which answers or details can be provided via the fusion or combination of: i) grid-level operational information, ii) contextualized information about the site, or iii) data obtained from the measurement of the power usage or generation at the site. For instance, the systems and methods can provide the benefits of energy measurement and data processing using the fusion of information sources discussed herein, via an interface to the site-energy space, e.g., a natural-language interaction via a natural-language interface (NLI). The NLI can allow client devices (e.g., consumers) to interact with the metering platform to provide relevant questions (e.g., prompted by the system), make decisions on energy choices, or optimally configure or control flexible or controllable loads and DERs. The features or operations discussed herein may be powered by a computing platform located in the electric meter at the site, executing an NLM. Using the NLM can be relatively more interactive for consumers, for instance, compared to a library lookup, because varying combinations of data can be used for training the model depending on the direction or path of the conversation between the user and the NLM.

The NLM can be integrated within an edge-energy framework (EEF) with capabilities to ensure high-quality and safe results. For example, the EEF can provide the NLM with energy knowledge and definitions to increase output quality. In another example, the EEF can manage inputs, execution, or outputs of the NLM to ensure data privacy, equipment safety, output quality, etc. The NLM can learn from local electrical usage or generation and grid conditions, allowing tailored answers tailored to the respective site. The data or analysis of the data can be performed locally on the meter for privacy and data security purposes. For instance, approved data may leave the site and unapproved data (with potential privacy risk) may not leave the site to protect the privacy of consumers or residents.

This disclosure is directed to a system for utility grid management. The system can include a grid edge device (e.g., a metering device) comprising one or more processors coupled to memory and positioned at a grid edge. The grid edge device can receive at least one query from an interface application, and manage the execution of NLMs including prompt structuring, NLM pipeline optimization, and integration with information sources, in order to generate computer code relevant to that query. The grid edge device can generate code that performs at least one of accessing local electrical and related data stored locally on the grid edge device, performing analysis of at least a portion of the local electrical and related data relevant to a query (e.g., received from a client device), and processing results from the analysis to provide a response (e.g., including a summary or information of the results) to the query for display via an interface application. The grid edge device can generate code that monitors data produced by the metering device in real-time and reports ongoing status messages, alerts, or summaries relevant to the query for display via the interface application. The grid edge device can generate code that executes actions to at least one of managing or controlling connected electrical devices relevant to the query and reporting outcomes for display via an interface application.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

Aspects of the technical solutions are directed to a system. The system can be a system to interact with an electric metering platform. The system can include a grid edge device including one or more processors that can be coupled with memory. The system can include the one or more processors that are configured (e.g., via instructions and data stored in memory). The one or more processors can be configured to receive, via an interface of the grid edge device, an input query related to a characteristic of electricity at a site located at an edge of an electric distribution grid. The one or more processors can be configured to retrieve, from memory, data for the grid edge device. The data can include: i) contextual information for the site at which the grid edge device is located, ii) operational data from one or more controllable devices located at the site, and iii) a metering signal data set generated via signal processing on electrical metering signals related to the site. The one or more processors can be configured to construct a prompt data structure using one or more generative artificial intelligence (AI) techniques based on the input query and the data for the grid edge device. The one or more processors can be configured to generate, using the one or more generative AI techniques on the grid edge device, processor-executable code responsive to the prompt data structure. The one or more processors can be configured to execute the processor-executable code to generate output responsive to the input query. The one or more processors can be configured to perform an action in accordance with the output.

The one or more processors can be configured to classify the input as a first type of a plurality of types. The one or more processors can be configured to select an agent from a plurality of different types of agents configured with the one or more generative artificial techniques. The one or more processors can be configured to generate the processor-executable code using the selected agent.

The one or more processors can be configured to classify the first type of the plurality of types of agents, wherein the plurality of types of agent include at least one of an analyst agent, a monitoring agent, or an action agent. The one or more processors can be configured to authenticate a provider of the input query; and grant access to retrieve the data for the grid edge device responsive to the authentication.

The one or more processors can be configured to identify a boundary constraint for the grid edge device based on the data. The one or more processors can be configured to construct the prompt data structure to include an indication of the boundary constraint. The one or more processors can be configured to generate the output in accordance with the boundary constraint. The boundary constraint can be a physics-based constraint for the grid edge device.

The one or more processors can be configured to determine to validate the generated processor-executable code prior to execution on the grid edge device. The one or more processors can be configured to execute, responsive to the determination, the generated processor-executable code in a framework environment on the grid edge device. The one or more processors can be configured to validate the generated processor-executable code based on a successful execution of the generated code in the framework environment. The one or more processors can be configured to execute, responsive to the validation, the generated processor-executable code on the grid edge device to generate the output.

The one or more processors can be configured to determine to perform the validation of the processor-executable code based on at least one of: a comparison of the processor-executable code with historically executed code stored in memory, an evaluation of the processor-executable code using one or more rules prior to the execution of the processor-executable code, determination of a performance of the processor-executable code during the execution of the processor-executable code, evaluation of the processor-executable code using the one or more generative AI techniques, or a simulation of an execution of the processor-executable code.

The one or more processors can be configured to determine to perform the validation of the processor-executable code based on a severity of a boundary constraint of the grid edge device. The one or more processors can be configured to select, using machine learning (ML), a format configured to render the output. The format can include at least one of text, natural language speech, graph, or an image; translate the output to the selected format. The one or more processors can be configured to provide, to an output device of the grid edge device, the translated output. The one or more processors can be configured to control a controllable device of the one or more controllable devices in accordance with at least one of the processor-executable code or the output. The one or more processors can be configured to request, subsequent to receipt of the input query, information to construct the prompt data structure; and construct the prompt data structure based on further information received responsive to the request. The one or more processors can be configured to iteratively update the prompt data structure based on one or more additional requests for information. The one or more processors can be configured to store, in a local knowledge base on the edge device, the information received responsive to the one or more additional requests.

An aspect of the technical solutions is directed to a method of interacting with an electric metering platform. The method can include receiving, by a grid edge device comprising one or more processors, coupled with memory, via an interface of the grid edge device, an input query related to a characteristic of electricity at a site located at an edge of an electric distribution grid. The method can include retrieving, by the grid edge device, from memory, data for the grid edge device. The data can include: i) contextual information for the site at which the grid edge device is located, ii) operational data from one or more controllable devices located at the site, and iii) a metering signal data set generated via signal processing on electrical metering signals related to the site. The method can include constructing, by the grid edge device, using one or more generative AI techniques, a prompt data structure based on the input query and the data for the grid edge device. The method can include generating, by the grid edge device, using the one or more generative AI techniques on the grid edge device, processor-executable code responsive to the prompt data structure. The method can include executing, by the grid edge device, the processor-executable code to generate output responsive to the input query. The method can include performing, by the grid edge device, an action in accordance with the output.

The method can include classifying, by the grid edge device, the input as a first type of a plurality of types. The method can include selecting, by the grid edge device, an agent from a plurality of different types of agents configured with the one or more generative artificial techniques. The method can include generating, by the grid edge device, the processor-executable code using the selected agent. The method can include authenticating, by the grid edge device, a provider of the input query. The method can include granting, by the grid edge device, access to retrieve the data for the grid edge device responsive to the authentication.

The method can include identifying, by the grid edge device, a boundary constraint for the grid edge device based on the data. The method can include constructing, by grid edge device, the prompt data structure to include an indication of the boundary constraint. The method can include generating, by the grid edge device, the output in accordance with the boundary constraint. The method can include determining, by the grid edge device, to validate the generated processor-executable code prior to execution on the grid edge device. The method can include executing, by the grid edge device, responsive to the determination, the generated processor-executable code in a framework environment on the grid edge device. The method can include validating, by the grid edge device, the generated processor-executable code based on a successful execution of the generated code in the framework environment. The method can include executing, by the grid edge device, responsive to the validation, the generated processor-executable code on the grid edge device to generate the output.

An aspect of the technical solutions is directed to a non-transitory computer-readable medium storing processor-executable instructions. The instructions, when executed by one or more processors, can cause the one or more processors to receive, via an interface of a grid edge device, an input query related to a characteristic of electricity at a site located at an edge of an electric distribution grid. The instructions, when executed by one or more processors, can cause the one or more processors to retrieve, from memory, data for the grid edge device. The data can include: i) contextual information for the site at which the grid edge device is located, ii) operational data from one or more controllable devices located at the site, and iii) a metering signal data set generated via signal processing on electrical metering signals related to the site. The instructions, when executed by one or more processors, can cause the one or more processors to construct a prompt data structure using one or more generative AI techniques based on the input query and the data for the grid edge device. The instructions, when executed by one or more processors, can cause the one or more processors to generate, using the one or more generative AI techniques on the grid edge device, processor-executable code responsive to the prompt data structure. The instructions, when executed by one or more processors, can cause the one or more processors to execute the processor-executable code to generate output responsive to the input query. The instructions, when executed by one or more processors, can cause the one or more processors to perform an action in accordance with the output.

The instructions, when executed by one or more processors, can cause the one or more processors to classify the input as a first type of a plurality of types. The instructions, when executed by one or more processors, can cause the one or more processors to select an agent from a plurality of different types of agents configured with the one or more generative artificial techniques. The instructions, when executed by one or more processors, can cause the one or more processors to generate the processor-executable code using the selected agent.

### BRIEF DESCRIPTION OF THE FIGURES

The accompanying drawings are not intended to be drawn to scale. Like reference numbers and designations in the various drawings indicate like elements having similar structure or functionality. For purposes of clarity, not every component may be labeled in every drawing. In the drawings:

FIG. 1 is a block diagram depicting an illustrative utility grid, in accordance with an implementation.

FIG. 2 is a block diagram of a data processing system on a grid edge device, in accordance with an implementation.

FIG. 3 is a block diagram of components of an AI framework (e.g., an edge energy framework), in accordance with an implementation.

FIG. 4 is a block diagram illustrating an architecture for a computer system that can be employed to implement elements of the systems and methods described and illustrated herein, including, for example, aspects of the utility grid depicted in FIGS. 1-3.

FIG. 5 is a flow diagram of a method for interacting with an electric metering platform, in accordance with an implementation.

The features and advantages of the present solution will become more apparent from the detailed description set forth below when taken in conjunction with the drawings, in which like reference characters identify corresponding elements throughout. Other features, aspects, and advantages of the subject matter will become apparent from the description, the drawings, and the claims.

### DETAILED DESCRIPTION

Following below are more detailed descriptions of various concepts related to, and implementations of, methods, apparatuses, and systems of natural-language-interactive electric-metering platform. The various concepts introduced above and discussed in greater detail below may be implemented in any of numerous ways.

In utility distribution grids, meters or other components within utility distribution grids can collect samples of power delivery or consumption at respective sites (e.g., residential homes, facilities, or entities) for processing. In certain cases, loads can be fed or operated from diverse energy sources, e.g., gasoline, propane, oil, wood, natural gas, or electricity. These loads may include, but are not limited to, heating, cooling, cooking, appliances, equipment, yard tools, automobiles, or other loads at the grid edge. Because of the continuing electrification, these loads (e.g., appliances, devices, items, or machines) may be unified under a single energy source (e.g., electricity). With the electrification and unification of the loads or electrical devices at the grid edge under the single energy source, it may be challenging for electric utilities to support the increased current flows. For instance, the process of upgrading the physical equipment to support the increased current flows may be longer than the pace of electrification, potentially risking early failure of utility equipment due to overuse.

In certain systems, a non-physical approach may be implemented, such as modulating flexible or controllable loads via pricing, discouraging use at peak times to reduce electrical usage at certain time periods (e.g., flatten the curve). For example, as the total current flows increase, the peak levels can be maintained below predefined hardware limits. In some cases, the non-physical approach may include charging energy storage at the edge during off-peak times and discharging the energy storage during peak times, alleviating the magnitude of modulation by the flexible or controllable loads. The tradeoff for such non-physical implementations may involve the extended utilization of existing, physical grid infrastructure (e.g., reducing cost for consumers through the deferral of equipment upgrades) at the expense of complexifying its end-to-end operation (e.g., actions taken by the consumer). The increase in complexity may demand more actions to be taken by the consumers for cost-effective use of energy, for instance, compared to the diverse energy sources. To address these challenges from the electrification of loads, the systems and methods of the technical solution can provide the ability to measure power consumption and generation at the grid edge (e.g., sampled by the respective meters) and process the data (e.g., by the meters at the site) to assist the consumers as discussed herein.

For example, various benefits can be provided to the consumers by implementing the energy measurement and data processing techniques discussed herein, including in the categories of reliability, billing, and optimization of flexible or controllable loads and DERs. Each category may include topics of interest to the consumers, in which answers or details can be provided (to the consumers) via the fusion or combination of: i) grid-level operational information, ii) contextualized information about the site, or iii) data obtained from the measurement of the power usage or generation at the site, for example.

The systems and methods can provide the benefits of energy measurement and data processing using the fusion of information sources discussed herein, via an interface to the site-energy space, e.g., NLI. The NLI can allow consumers to interact with the metering platform to provide relevant questions (e.g., prompted by the system), make decisions (or take actions) on energy choices, or optimally configure or control flexible or controllable loads and DERs. The features or operations discussed herein may be powered by a computing platform located in the electric meter at the site, executing an NLM. Using the NLM can be relatively more interactive for consumers, for instance, compared to a library lookup, because varying combinations of data (e.g., different types of data or information sources) can be used for training the model depending on the direction or path of the conversation between the user and the NLM.

The NLM can be integrated within an EEF with capabilities to ensure high-quality and safe results. For example, the EEF can provide the NLM with energy knowledge and definitions (e.g., computation techniques, types of collected data, description of DERs controllable by the system, or information on devices within the utility grid or at the site) to increase output quality. In another example, the EEF can manage inputs, execution, or outputs of the NLM to ensure data privacy, equipment safety, output quality, etc. The NLM can learn from local electrical usage or generation and grid conditions, allowing the NLM to provide answers tailored to the respective site (e.g., to the residential home or entity associated with the meter). In various configurations, the data or analysis of the data can be performed locally on the meter, such that predefined approved information may leave the site (e.g., uploaded to the cloud) for privacy and data security. In such configurations, unapproved data or information with potential privacy risk may not leave the site for privacy protection.

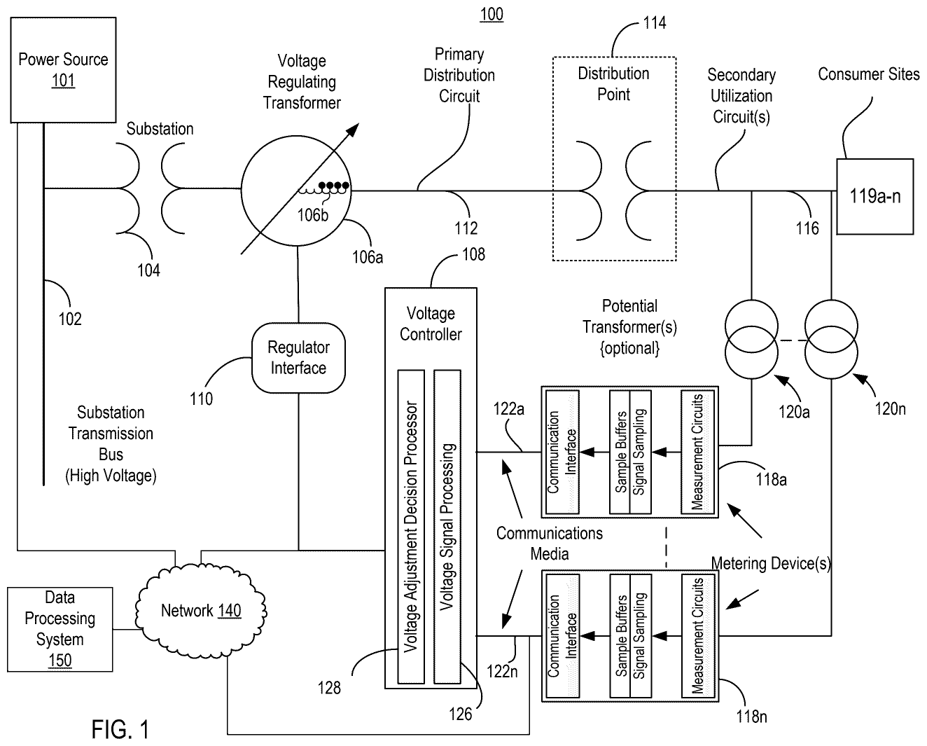

FIG. 1 depicts an example utility distribution environment. The utility distribution environment can include a utility grid 100. The utility grid 100 can include an electricity distribution grid with one or more devices, assets, or digital computational devices and systems, such as a data processing system 150. In brief overview, the utility grid 100 includes a power source 101 that can be connected via a subsystem transmission bus 102 or via a substation transformer 104 to a voltage regulating transformer 106a. The voltage regulating transformer 106a can be controlled by voltage controller 108 with regulator interface 110. Voltage regulating transformer 106a can be optionally coupled on primary distribution circuit 112 via optional distribution transformer 114 to secondary utilization circuits 116 and to one or more electrical or electronic devices 119. Voltage regulating transformer 106a can include multiple tap outputs 106b with each tap output 106b supplying electricity with a different voltage level. The utility grid 100 can include monitoring devices 118a-118n that can be coupled through optional potential transformers 120a-120n to secondary utilization circuits 116. The monitoring or metering devices 118a-118n can detect (e.g., continuously, periodically, based on a time interval, or responsive to an event or trigger) measurements and continuous voltage signals of electricity supplied to one or more electrical devices 119 connected to primary distribution circuit 112 or secondary utilization circuits 116 from a power source 101 coupled to subsystem transmission bus 102. A voltage controller 108 can receive, via a communication media 122, measurements obtained by the metering devices 118a-118n, and use the measurements to make a determination regarding a voltage tap settings, and provide an indication to regulator interface 110. The regulator interface can communicate with voltage regulating transformer 106a to adjust an output tap level 106b.

The utility grid 100 can include a power source 101. The power source 101 can include a power plant such as an installation configured to generate electrical power for distribution. The power source 101 can include an engine or other apparatus that generates electrical power. The power source 101 can create electrical power by converting power or energy from one state to another state. In some embodiments, the power source 101 can be referred to or include a power plant, power station, generating station, powerhouse, or generating plant. In some embodiments, the power source 101 can include a generator, such as a rotating machine that converts mechanical power into electrical power by creating relative motion between a magnetic field and a conductor. The power source 101 can use one or more energy sources to turn the generator including, e.g., fossil fuels such as coal, oil, and natural gas, nuclear power, or cleaner renewable sources such as solar, wind, wave and hydroelectric.

In some embodiments, the utility grid 100 includes one or more substation transmission buses 102. The substation transmission bus 102 can include or refer to a transmission tower, such as a structure (e.g., a steel lattice tower, concrete, wood, etc.), that supports an overhead power line used to distribute electricity from a power source 101 to a substation 104 or distribution point 114. Transmission towers 102 can be used in high-voltage AC and DC systems, and come in a wide variety of shapes and sizes. In an illustrative example, a transmission tower can range in height from 15 to 55 meters or more. Transmission towers 102 can be of various types including, e.g., suspension, terminal, tension, and transposition. In some embodiments, the utility grid 100 can include underground power lines in addition to or instead of transmission towers 102.

In some embodiments, the utility grid 100 includes a substation 104 or electrical substation 104 or substation transformer 104. A substation can be part of an electrical generation, transmission, and distribution system. In some embodiments, the substation 104 transforms voltage from high to low, or the reverse, or performs any of several other functions to facilitate the distribution of electricity. In some embodiments, the utility grid 100 can include several substations 104 between the power plant 101 and the consumer electrical devices 119 with electric power flowing through them at different voltage levels.

The substations 104 can be remotely operated, supervised and controlled (e.g., via a supervisory control and data acquisition system or data processing system 150). A substation can include one or more transformers to change voltage levels between high transmission voltages and lower distribution voltages, or at the interconnection of two different transmission voltages.

The regulating transformer 106 can include (1) a multi-tap autotransformer (single or three-phase), which is used for distribution; or (2) an on-load tap changer (three-phase transformer), which can be integrated into a substation transformer 104 and used for both transmission and distribution. The illustrated system described herein can be implemented as either a single-phase or three-phase distribution system. The utility grid 100 can include an alternating current (AC) power distribution system and the term voltage can refer to a root mean square voltage, in some embodiments.

The utility grid 100 can include a distribution point 114 or distribution transformer 114, which can refer to an electric power distribution system. In some embodiments, the distribution point 114 can be a final or near-final stage in the delivery of electric power. For example, the distribution point 114 can carry electricity from the transmission system (which can include one or more transmission towers 102) to individual consumers 119. In some embodiments, the distribution system can include the substations 104 and connect to the transmission system to lower the transmission voltage to medium voltage ranging between 2 kV and 35 kV with the use of transformers, for example. Primary distribution lines or circuit 112 carry this medium voltage power to distribution transformers located near the customer's premises 119. Distribution transformers can further lower the voltage to the utilization voltage of appliances and can feed several customers 119 through secondary distribution lines or circuits 116 at this voltage. Commercial and residential customers 119 can be connected to the secondary distribution lines through service drops. In some embodiments, customers demanding high load can be connected directly at the primary distribution level or the sub-transmission level.

The utility grid 100 can include or couple to one or more consumer sites 119. Consumer sites 119 can include, for example, a building, house, shopping mall, factory, office building, residential building, commercial building, stadium, movie theater, etc. The consumer sites 119 can be configured to receive electricity from the distribution point 114 via a power line (above ground or underground). A consumer site 119 can be coupled to the distribution point 114 via a power line. The consumer site 119 can be further coupled to a site meter 118a-n or advanced metering infrastructure (AMI). The site meter 118a-n can be associated with a controllable primary circuit segment 112. The association can be stored as a pointer, link, field, data record, or other indicator in a data file in a database.

The utility grid 100 can include site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer-associated systems, Meter Data Management (MDM) software, or supplier business systems. In some embodiments, the site meters 118a-n can obtain samples of electricity usage in real time or based on a time interval and convey, transmit, or otherwise provide the information. In some embodiments, the information collected by the site meter can be referred to as meter observations or metering observations and can include the samples of electricity usage. In some embodiments, the site meter 118a-n can convey the metering observations along with additional information such as a unique identifier of the site meter 118a-n, a unique identifier of the consumer, a time stamp, a date stamp, a temperature reading, a humidity reading, an ambient temperature reading, etc. In some embodiments, each consumer site 119 (or electronic device) can include or be coupled to a corresponding site meter or monitoring device 118a-118n.

Monitoring devices 118a-118n can be coupled through communications media 122a-122n to voltage controller 108. Voltage controller 108 can compute (e.g., discrete-time, continuously or based on a time interval or responsive to a condition or event) values for electricity that facilitate regulating or controlling electricity supplied or provided via the utility grid. For example, the voltage controller 108 can compute estimated deviant voltage levels that the supplied electricity (e.g., supplied from power source 101) will not drop below or exceed as a result of varying electrical consumption by the one or more electrical devices 119. The deviant voltage levels can be computed based on a predetermined confidence level and the detected measurements. Voltage controller 108 can include a voltage signal processing circuit 126 that receives sampled signals from metering devices 118a-118n. Metering devices 118a-118n can process and sample the voltage signals such that the sampled voltage signals are sampled as a time series (e.g., a uniform time series free of spectral aliases or a non-uniform time series).

Voltage signal processing circuit 126 can receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element,” “hardware,” “device,” or “apparatus” could be used synonymously with or in place of the term “circuit” and can perform the same function. For example, in some embodiments, the functionality can be carried out using one or more digital processors, e.g., implementing one or more digital signal processing algorithms. The adjustment decision processor circuit 128 can determine a voltage location with respect to a defined decision boundary and set the tap position and settings in response to the determined location. For example, the adjustment decision processing circuit 128 in the voltage controller 108 can compute a deviant voltage level that is used to adjust the voltage level output of electricity supplied to the electrical device. Thus, one of the multiple tap settings of the regulating transformer 106 can be continuously selected by the voltage controller 108 via the regulator interface 110 to supply electricity to the one or more electrical devices based on the computed deviant voltage level. The voltage controller 108 can also receive information about voltage regulator transformer 106a or output tap settings 106b via the regulator interface 110. Regulator interface 110 can include a processor-controlled circuit for selecting one of the multiple tap settings in voltage regulating transformer 106 in response to an indication signal from the voltage controller 108. As the computed deviant voltage level changes, other tap settings 106b (or settings) of regulating transformer 106a are selected by voltage controller 108 to change the voltage level of the electricity supplied to the one or more electrical devices 119.

The network 140 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel, or a satellite band. The wireless links can also include any cellular network standards used to communicate among mobile devices, including standards that qualify as 1G, 2G, 3G, or 4G. The network standards can qualify as one or more generations of mobile telecommunication standards by fulfilling a specification or standards such as the specifications maintained by the International Telecommunication Union. The 3G standards, for example, can correspond to the International Mobile Telecommunications-3000 (IMT-3000) specification, and the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods, e.g., FDMA, TDMA, CDMA, or SDMA. In some embodiments, different types of data can be transmitted via different links and standards. In other embodiments, the same types of data can be transmitted via different links and standards.

The network 140 can be any type or form of network. The geographical scope of the network 140 can vary widely and the network 140 can be a body area network (BAN), a personal area network (PAN), a local-area network (LAN), e.g., Intranet, a metropolitan area network (MAN), a wide area network (WAN), or the Internet. The topology of the network 140 can be of any form and can include, e.g., any of the following: point-to-point, bus, star, ring, mesh, or tree. The network 140 can be an overlay network which is virtual and sits on top of one or more layers of other networks 140. The network 140 can be of any such network topology as known to those ordinarily skilled in the art capable of supporting the operations described herein. The network 140 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include the application layer, transport layer, internet layer (including, e.g., IPv6), or the link layer. The network 140 can be a type of a broadcast network, a telecommunications network, a data communication network, or a computer network.

The network 140 can include computer networks such as the internet, local, wide, near-field communication, metro or other area networks, as well as satellite networks or other computer networks such as voice or data mobile phone communications networks, and combinations thereof. The network 140 can include a point-to-point network, broadcast network, telecommunications network, asynchronous transfer mode network, synchronous optical network, or a synchronous digital hierarchy network, for example. The network 140 can include at least one wireless link, such as an infrared channel or satellite band. The topology of the network 140 can include a bus, star, or ring network topology. The network 140 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

One or more components, assets, or devices of utility grid 100 can communicate via network 140. The utility grid 100 can use one or more networks, such as public or private networks. The utility grid 100 can communicate with or interface with a data processing system 150 designed and constructed to communicate with, interface with or control the utility grid 100 via network 140. Each asset, device, or component of utility grid 100 can include one or more computing devices 300 or a portion of computing device 300 or some or all functionality of computing device 300.

The data processing system 150 can reside on a computing device of the utility grid 100, or on a computing device or server external from, or remote from the utility grid 100. The data processing system 150 can reside or execute in a cloud computing environment or distributed computing environment. The data processing system 150 can reside on or execute on multiple local computing devices located throughout the utility grid 100. For example, the utility grid 100 can include multiple local computing devices, each configured with one or more components or functionalities of the data processing system 150.

Each of the components of the data processing system 150 can be implemented using hardware or a combination of software and hardware. Each component of the data processing system 150 can include logical circuitry (e.g., a central processing unit or CPU) that responds to and processes instructions fetched from a memory unit (e.g., memory 415 or storage device 425). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction-level parallelism, thread-level parallelism, different levels of cache, etc. For example, the data processing system 150 can include at least one logic device, such as a computing device or server, having at least one processor to communicate via the network 140.

The components and elements of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. The components of the data processing system 150 can be connected or communicatively coupled to one another. The connection between the various components of the data processing system 150 can be wired or wireless, or any combination thereof. Counterpart systems or components can be hosted on other computing devices.

The data processing system 150 can communicate with one or more metering devices 118 via the network 140. In some cases, the data processing system 150 can include features or functionalities of the metering devices 118. In some other cases, the data processing system 150 can be a part of the metering device 118, such that the metering device 118 can perform certain features or functionalities of the data processing system 150. The data processing system 150 can include a graphical user interface (GUI) to display information to the user. The data processing system 150 can include one or more processing units, such as a graphics processing unit (GPU), to perform local processing at a local site (e.g., grid edge or at a residential area). For purposes of providing examples herein, the data processing system 150 may be a metering device 118 or an edge device configured to perform the features or operations discussed herein (e.g., processing data locally or providing an interactive interface for controlling or managing loads and DERs). It should be noted that, in some cases, other devices or systems at the edge of the utility grid 100 can be supported or configured to perform the features or operations discussed herein, not limited to the data processing system 150.

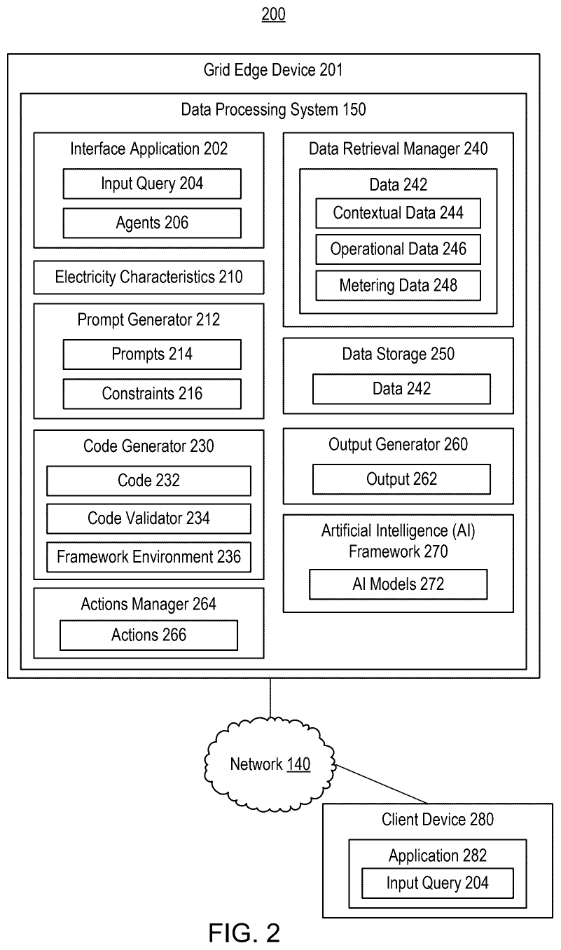

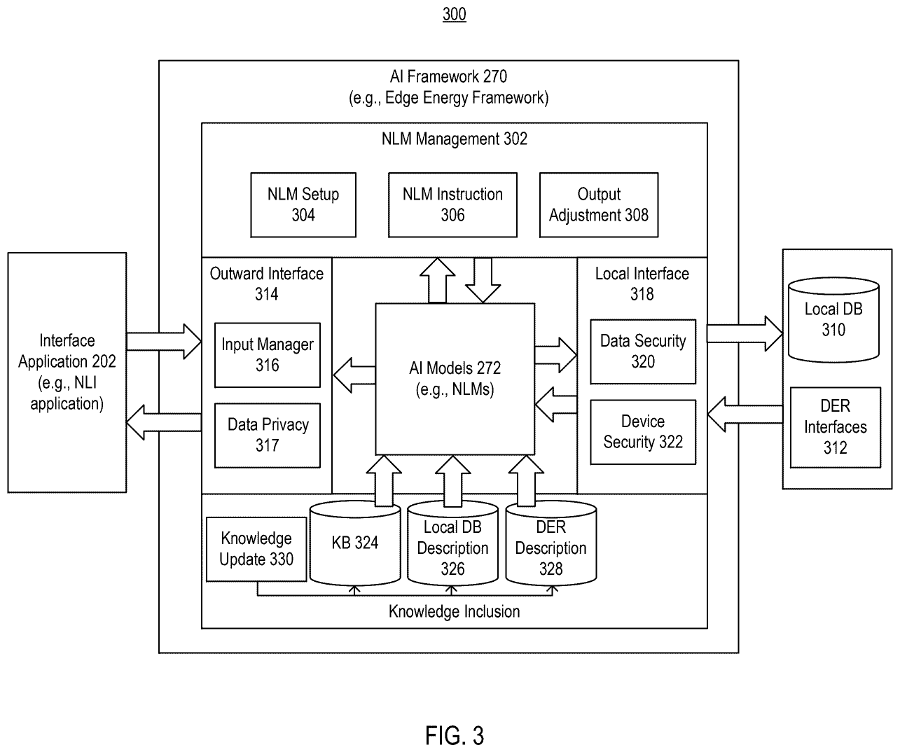

The data processing system 150 can include, correspond to, or be a part of a natural-language, interactive, metering platform. The metering platform can be described in conjunction with at least FIG. 2 or 3. For example, the data processing system 150 can include one or more features or capabilities of the natural-language, interactive, metering platform for execution on the grid edge, including at least one of, but not limited to, a local NLM (e.g., a generative pretrained transformer), a knowledge base (KB), a local database (DB), an EEF, and a natural-language interface application.

The local NLM can be housed in the metering device 118 (e.g., data processing system 150) at the site. The NLM can be embedded in the EEF and utilizes the KB to perform analysis, prompt questions, provide answers to questions, create monitors or alerts, take actions, etc. Using the NLM can facilitate interaction between the users (or consumers) and the platform and generate responses according to the path or direction of the conversation (e.g., considers conversation history and context for purposes of generating relevant responses). In other words, the NLM can allow for more accessibility of desired information. The NLM can be trained on contextualized information for the specific site or location of the metering device 118, applicable to the site itself and the site location on the grid. For example, the NLM can be trained using at least one of the configuration protocols (e.g., application programming interfaces (APIs)) for various makes and models of flexible or controllable loads or DERs in the site, efficiency of appliances or equipment within the site, electricity tariffs of the distribution utility, electricity-use patterns at the site, electric-panel rating at the site, secondary voltage transformer historic load profile of the site, or characteristics of grid-provided power at that location (e.g., voltage levels and stability, power quality, or frequency stability), among other information associated with the site itself or the site location.

The KB can include/contain general and proprietary information relevant to electric distribution and end-use energy, contextual information about the site itself and the site location on the grid, information gathered from analyzing the data produced from local electrical metering (e.g., the metering device 118), etc. The NLM can use the KB to understand the contextualized information and conduct analysis to produce answers to user-posed questions as well as actions that are facilitated by the metering platform (e.g., creating alerts based on monitored conditions or changing settings on controllable loads or DERs). The KB can be expanded or improved over time by incorporating information such as user feedback, user answers (e.g., when prompting for clarification), information learned from user interaction, or updated or new insights from new data as measured, stored, or processed, including the processed outputs using the data.

The local DB can store at least one of operational data from the local controllable devices (e.g., flexible or controllable loads or DERs), an information-rich dataset obtained from statistical signal processing, or physics or machine-learning-based models operating on the raw, local electrical metering signals. The local DB can support storing relatively large amounts of relevant historical data, for instance, to provide low latency for communication and decision-making and allow for access to relatively large amounts of historical data, which may not be feasible (e.g., consume extensive resources) to send to the cloud. Storing data in the local DB can provide user privacy as sensitive data is maintained locally at the site of the measurement, reduce resource consumption by minimizing data transmission to the cloud, and minimize latency by using the locally stored data.

The EEF can encapsulate the various elements or components discussed herein, including but not limited to at least one of the NLM, KB, or local DB. The EEF can utilize the KB and the local DB to provide application-specific knowledge to the NLM. The EEF can manage the input, execution, or output of the NLM to ensure proper inputs are used and desired outputs are obtained, e.g., providing safe and high-quality results for controlling the loads or DERs. For example, the EEF can provide application-specific knowledge to the NLM via at least one of the KB (e.g., including general and proprietary information relevant to electric distribution, analysis of electricity and energy data, or equipment knowledge), the definition of local data (e.g., sometimes referred to as local data definition or description) being measured or produced and how to interpret and analyze the local data, the definition (or description) of the available DER actions and the potential results of the actions, or prompting instructions or other NLM inputs to assist in guiding the NLM to high-quality (desired) outcomes or outputs.

In another example, the EEF can manage the input, execution, and output of the NLM for proper utilization of inputs and generation of the outputs. Managing the input, execution, and output can include at least a verification of data privacy for any data being exported from the device (e.g., metering device 118 or data processing system 150), including the understanding and enforcing of customer privacy preferences and criteria. Managing the input, execution, and output can include enforcing the electrical and equipment safety for any actions that are taken, e.g., ensuring that instructions for the DER are within operational limits given the site and grid status. Managing the input, execution, and output can include improving result quality by managing NLM execution processes. In this case, multiple approaches can be performed to improve the quality of NLM outputs, such as reflection and code evaluation.

The natural-language interface application may sometimes be referred to generally as an interface application for the EEF or the metering platform, for example. The interface application can be included or installed on a client device, such as a smartphone, tablet, computer, etc., as the basis for the user interaction with the metering platform. The interface application can include a user interface supporting predefined user interaction to communicate with the metering platform.

FIG. 2 illustrates an example of a system 200 for interacting with an electric metering platform. The system 200 can include one or more client devices 280 communicating, via one or more networks 140, with a grid edge device 201 that can include, execute, access or utilize one or more data processing systems 150. The one or more client devices 280 can operate applications 282 for generating input queries 204 for transmission (e.g., via network 140) to a data processing system 150 on a grid edge device 201, which can include any grid device, such as a metering device 118, or any other system coupled with the grid. The data processing system 150 can include one or more of the interface applications 202 for receiving and processing input queries 204 using agents 206. The data processing system 150 can include, monitor, detect, or identify electricity characteristics 210 that can be referred to, or related to, the input queries 204. The data processing system 150 can include one or more data retrieval managers 240 for retrieving, from a data storage 250, various data 242. The data 242 can include contextual data 244 having information for the site of the grid edge device 201 (e.g., the metering device 118), operational data 246 for controllable devices at the site, and metering data 248 processed from electrical metering signals of the site. The data processing system 150 can include one or more prompt generators 212 for generating or constructing prompts 214 (e.g., prompt data structures) according to constraints 216, and using an input query 204 and data 242 input into one or more AI models 272. The data processing system 150 can include one or more code generators 230 to generate code 232 responsive to the prompt 214 and using one or more code validators 234 to validate the code 232 using a framework environment 236. The data processing system 150 can include one or more output generators 260 for executing the processor-executable code 232 to generate one or more outputs 262 responsive to the input query 204. The prompt generator 212, the code generator 230, and the output generator 260 can utilize any AI functionalities of the AI framework 270, including any AI models 272. The data processing system 150 can include one or more actions managers 264 for performing or providing actions 266, based on, responsive to, or in accordance with, any outputs 262 or generated processor-executable code 232.

The grid edge device 201 can include any device, system, or service on which a data processing system 150 can be utilized or deployed. Grid edge device 201 can include a computing device, such as a physical or a virtual server, a software as a service (SaaS) service on a cloud-based system, or a grid device, such as a power source 101, substation 104, voltage regulating transformer 106, voltage controller 108, regulator interface 110, or a metering device 118. For instance, the grid edge device 201 can be a metering device 118, a smart thermostat device, a DER device, a smart appliance, a home energy management system (HEMS), or any other device or a component of a system 100 or 200. The grid edge device 201 can be a metering device 118 at a particular site or a location (e.g., a local grid, or a portion of a grid) and can be utilized to manage or operate electricity services at that location.

Data processing system 150 can be any combination of hardware and software for providing interaction with an electric metering platform. Data processing system 150 can be deployed on a grid edge device 201 (e.g., a metering device 118), or any other portion of a grid or system or a component that can be coupled with the grid, such as a cloud-based software as a service (SaaS) system. The grid edge device 201 can include one or more processors (e.g., 410) that can be coupled with memory (e.g., 415, 420, or 425) and configured (e.g., via instructions, commands, or data stored in the memory to implement various features or functionalities of the data processing system 150 described herein. For instance, the data processing system 150 can be configured to implement functionalities of the interface application 202, prompt generator 212, data retrieval manager 240, code generator 230, code validator 234, output generator 260, and actions manager 264, including any functionalities of the AI framework 270. The data processing system 150 can communicate with client devices 280 and can process input queries 204, retrieve data 242, generate prompts 214, validate code 232, and execute actions 264 (e.g., responsive to outputs 262 generated responsive to input queries 204) to manage electricity usage and control of various grid systems and devices. For example, a data processing system 150 can be used to optimize energy consumption in a residential home or a neighborhood, at a site location of an industrial or service complex of buildings or any other site by interacting with various smart devices across the grid.

Electricity characteristics 210 can include any type and form of attributes or properties of the electrical power being delivered or consumed at a site of a grid edge device 201. Electricity characteristics 210 can include, for example, voltage levels, current flow, power consumption, power generation, frequency stability, or power quality. Electricity characteristics 210 can include characteristics, attributes, or properties of power, voltage or current that can be utilized for analyzing, understanding, and managing the energy usage at the site. Electricity characteristics 210 can include variations in power, voltage, current, phase, or any other parameter or feature of electricity. The data processing system 150 can monitor and electrical characteristics 210 to generate prompts 214 for generating code 232, provide or generate output 262, or take actions by an actions manager 264.

Input query 204 can include any group of strings or characters indicating a question or a request for a data processing system 150. The input query 204 can include any request or command related to electricity characteristics at a site, such as a site of a grid edge device 201. Input query 204 can be generated by applications 282 on client devices 280 and transmitted to the data processing system 150 for processing and response generation. For example, a user can query the system to find out the projected electricity bill for a time period, or request action to be taken based on one or more electricity characteristics 210.

Agent 206 can include any combination of hardware and software for handling specific input queries 204 related to electricity usage or control. Agents 206 can be specialized software components for handling specific types of input queries. Agents 206 can include analyzing or analyst agents, monitoring or managing agents, or action agents, each designed to process input queries 204, manage alerts, or control devices based on the user's input. For instance, an analyzing agent 206 can provide statistics on energy consumption, while an action agent can take action to control a smart thermostat.

Interface application 202 can include any combination of hardware and software, such as any software application, for receiving and processing input queries from users or providing any responses (e.g., outputs 262 to the requesting client devices 280). Interface application 202 can be installed on a grid edge device 201 (e.g., metering device 118) or on any client devices 280, such as smartphones or computers. Interface application 202 can be configured to communicate with the data processing system 150 to facilitate user interaction with the metering platform. For instance, a user of an application 282 can use the interface application 202 (e.g., via an application 282 accessed by the user, via a local user interface, to generate a question or input query 204 about a specific electricity usage, which can then be processed by the data processing system 150 components.

The interface application 202 can be configured to execute on data processing system 150 of a grid edge device 201 to receive an input query 204, via a network 140, from a remote client device 280. The input query 204 can be related to an electricity characteristic 210 at a site located at an edge of an electric distribution grid at which the grid edge device 201 is deployed. The interface application 202 can be configured to classify the input query 204 as a first type of a plurality of types of the input query 204 and select an agent 206 from a plurality of different types of agents 206 configured with the one or more generative artificial techniques. For instance, the input query type can be a type of an input query 204 to monitor electricity, analyze electricity, and determine its characteristics or take action on the electricity. The interface application 202 can classify the first type of the plurality of types of agents 206. The plurality of types of agents can include at least one of an analyst agent, a monitoring agent, or an action agent. The interface application can authenticate a provider of the input query 204 and grant access to retrieve the data 242 for the grid edge device 201, responsive to the authentication.

Prompts 214 can include any data structures for instructing or guiding the operation of an AI model 272. A prompt 214 can include a data structure generated by a prompt generator 212 based on any combination of one or more input queries 204, contextual data 244, operational data 246, or metering data 248. A prompt 214 can be used to guide the AI models 272 in generating responses (e.g., code 232, outputs 262, or actions 266), such as based on the input queries 204 and retrieved data 242. For instance, a prompt 214 can instruct a generative AI model 272 to analyze historical energy usage data to predict future energy consumption or determine energy production from a DER on a grid.

Constraints 216 can include any combination of hardware and software to provide limits, ranges, or rules for generating prompts 214. A constraint 216 can include one or more predefined rules or limits used by the prompt generator 212 to ensure the generated prompts 214 are within a predetermined range of accuracy or contextual relevance. A constraint 216 can include one or more operational limits, data privacy rules, safety constraints, or contextual relevance similarity ranges for generating prompts 214. For example, constraints 216 can include values or parameters for a prompt 214 to maintain a system operation within a certain voltage level when controlling devices.

Prompt generator 212 can include any combination of hardware and software for constructing or generating prompts 214 for AI models 272, such as generative AI models 272 using prompts 214 for generating code 232. Prompt generator 212 can be a component for generating or constructing prompts based on input queries 204 and retrieved data 242. The prompt generator 212 can use constraints 216 and input data 242 to create prompt data structures for further processing by AI models 272. For example, a prompt generator 212 can generate a prompt 214 to retrieve specific data about energy consumption patterns. The generated prompts 214 can guide or instruct the AI models 272 in generating accurate and relevant responses, such as generating or validating processor-executable code 232.

The prompt generator 212 can be configured (e.g., via instructions and data stored in memory 415 for processing by a processor 410) to construct a prompt data structure (also referred to as a prompt 214) using one or more generative AI techniques (e.g., AI models 272). The prompt data structure can be constructed based on the input query 204 (e.g., received via the interface application 202) and the data 242 for the grid edge device 201. The data 242 can include the contextual data 244, operational data 246, or metering data 248 associated with the grid edge device 201, which can be stored (e.g., in association with the grid edge device 201) at a data storage 250.

The prompt generator 212 can be configured to identify a boundary constraint 216 for the grid edge device 201 based on the data 242. The prompt generator 212 can construct the prompt data structure 214 to include an indication of the boundary constraint 216. The prompt generator 212 can provide the prompt data structure (e.g., prompt 214) configured to be used by the output generator 260 to generate the output 262 in accordance with the boundary constraint 216. The boundary constraint 216 can include a physics-based constraint for the grid edge device, such as a maximum allowable voltage level to prevent overloading the system, a current limit to ensure that the electrical devices do not draw more current than the grid can safely supply, or a temperature threshold to prevent overheating of the grid edge device or connected equipment. The boundary constraint 216 can be a constraint 216 used to maintain the consistency of the electrical frequency, for checking the proper functioning of all connected devices.

The prompt generator 212 can be configured to request, subsequent to receipt of the input query 204, information or data to construct the prompt data structure (e.g., prompt 214). The prompt generator 212 can generate or construct the prompt data structure based on the further data or information received responsive to the request. The prompt generator 212 can iteratively update the prompt data structure based on one or more additional requests for information. The prompt generator 212 can store, in a local knowledge base on the edge device, the information received responsive to the one or more additional requests.

Code 232, sometimes also referred to as the processor-executable code 232, can include any combination of instructions or data for implementing computing operations, such as operations generating outputs 262 or implementing actions 266. Code 232 can be any computer-executable or processor-executable code, such as a processor-executable code generated by the code generator 230. Code 232 can be designed to perform actions, retrieve data, or control devices based on the input queries and prompts. For example, the code 232 can control a DER or an EV charger device to adjust charging or discharging cycles. The validated code 232 can be executed by the data processing system 150 to perform the specified actions 266.

Code generator 230 can include any combination of hardware and software for generating or validating code 232. Code generator 230 can include a component for generating processor-executable code 232 in response to prompts 214, using, for example, AI models 272. The code generator 230 can use AI models 272 to create code 232 that performs specific actions or operations or retrieves specific data 242 based on the input queries 204. For instance, a code generator 230 can generate code to adjust the settings of a smart thermostat based on user preferences. The generated processor-executable code 232 can be validated by a code validator 234 and executed or simulated within a framework environment 236 of a grid edge device 201 to verify if the code performs the desired actions 266.

The code generator 230 can be configured (e.g., via instructions and data stored in memory 415 for processing by a processor 410) to generate, using the one or more generative AI techniques on the grid edge device, processor-executable code 232 responsive to the prompt data structure (e.g., prompt 214). The code generator 230 can operate together with the interface application 202 to select an agent 206 (e.g., from a plurality of agents for a plurality of types of input queries 204) configured with the one or more generative artificial techniques (e.g., a particular AI model 272) to generate the processor-executable code 232 using the selected agent 206.

Code validator 234 can include any combination of hardware and software for validating or verifying code 232. Code validator 234 can be a component for validating the generated code before execution. Code validator 234 can check and verify that the code meets predefined criteria for correctness, security, or operational limits. Code validator 234 can execute or simulate code execution in a framework environment 236 and utilize predetermined inputs and outputs to verify correct operation. For instance, code validator 234 can simulate the code execution in a virtual framework environment 236 to verify its safety or accuracy of its responses. The validated code 232 can then be executed to perform the desired actions.

The code validator 234 can be configured (e.g., via instructions and data stored in memory 415 for processing by a processor 410) to determine to validate the generated processor-executable code 232 prior to execution of the code 232 on the grid edge device 201. The code validator 234 can be configured to execute, responsive to the determination, the generated processor-executable code 232 in a framework environment 236 on the grid edge device 201. The code validator 234 can be configured to validate (e.g., determine that it is valid) the generated processor-executable code 232 based on a successful execution of the generated code 232 in the framework environment 236. The code generator 230 can be configured to execute, responsive to the validation, the generated processor-executable code 232 on the grid edge device 201 to generate the output 262.

The code validator 234 can be configured (e.g., via instructions and data stored in memory 415 for processing by a processor 410) to determine to perform the validation of the processor-executable code 232 based on one or more actions, operations, or parameters. For instance, the code validator 234 can determine to perform the validation of the code 232 based on at least one of: a comparison of the processor-executable code with historically executed code stored in memory, an evaluation of the processor-executable code using one or more rules prior to the execution of the processor-executable code, a determination of the performance of the processor-executable code during the execution of the processor-executable code, an evaluation of the processor-executable code using the one or more generative AI techniques, or a simulation of an execution of the processor-executable code. The code generator 230 can determine to perform the validation of the processor-executable code 232 based on a severity of a boundary constraint 216 of the grid edge device 201, such as based on a determination that the boundary constraint 216 exceeds a predetermined threshold for that given constraint.

Framework environment 236 can be any virtual or simulated environment used by the code validator 234 to test the processor-executable code 232. Framework environment 236 can provide a safe space to verify the code's functionality and safety before deployment, such as a container or a sandbox. For example, framework environment 236 can simulate the operation of a smart grid to test the code's impact, which can help check that the code 232 operates correctly and safely in the real environment.

Data retrieval manager 240 can include any combination of hardware and software for retrieving data 242. Data retrieval manager 240 can be a component for retrieving data from data storage 250. Data retrieval manager 240 can access contextual data, operational data, and metering data to provide the necessary information for processing input queries and generating responses. For example, data retrieval manager 240 can retrieve historical energy usage data for analysis. The retrieved data 242 can then be used to generate accurate and relevant responses to user queries.

The data retrieval manager 240 can be configured (e.g., via instructions and data stored in memory 415 for processing by a processor 410) to retrieve, from the memory, data for the grid edge device. The data 242 can include any one or more of: i) contextual data 244 or information for the site at which the grid edge device is located, ii) operational data 246 from one or more controllable devices located at the site, or iii) metering data 248 (e.g., metering signal data set) generated via signal processing on electrical metering signals related to the site.

Data 242 can include any data used for generating prompts 214. Data 242 can include any combination of one or more of: contextual data 244, operational data 246, and metering data 248. Contextual data 244 can include any information about the grid site. Operational data 246 can include any information on controllable devices. Metering data 248 can include any information that can be processed from electrical metering signals. These data 242 of various types can be used individually, or in combination, to generate accurate and relevant responses to user input queries 204. The data processing system 150 can use this data to provide valuable insights and control devices.

Contextual data 244 can include any information about the grid site where the grid edge device 201 (e.g., metering device 118) is located. Contextual data 244 can include details such as the geographical location, site-specific energy consumption patterns, and historical data on energy usage. For example, contextual data 244 can include information about the typical (e.g., average or median) energy consumption of a residential home during different seasons. Contextual data 244 can be used by the data processing system 150 to tailor responses (e.g., outputs 262) and actions 266 based on the specific electrical characteristics 210 or other information about the site.

Operational data 246 can include any information on controllable devices at the grid site. This can involve data on the status, performance, and operational limits of devices such as smart thermostats, electric vehicle chargers, and DERs. For instance, operational data 246 can provide details on the current charging status of an electric vehicle or the efficiency of a solar panel system. Operational data 246 can allow the data processing system 150 to manage and optimize the operation of various grid devices.

Metering data 248 can include any information that can be processed from electrical metering signals at the grid site. Metering data 248 can include real-time or historical data on voltage levels, current flow, power consumption, and power generation. For example, metering data 248 can include detailed records of electricity usage at different times of the day. Metering data 248 can be used for analyzing energy consumption patterns, predicting future usage, and facilitating the efficient operation of the grid or providing accurate and actionable responses to users (e.g., on client devices 280).

Data storage 250 can be a storage system for storing data 242. Data storage 250 can include any storage devices, such as hard disks or hard drives, as well as any online cloud-based storage. Data storage 250 can include or provide databases or data structures for storing data in organized structures or formats for efficient access. Data storage 250 can maintain the contextual data 244, operational 246, and metering data 248 to be used for processing input queries 204 and generating responses or outputs 262. For example, data storage 250 can store data about the energy consumption patterns of a household. The stored data can be accessed by the data retrieval manager 240 to be used by the data processing system 150.

Outputs 262 can include any outputs generated by the output generator 260. Output 262 can include any of the results, such as a textual response to the input query 204. Output 262 can include information corresponding to actions based on the input queries 204. Output 262 can include electricity characteristics 210, electricity consumption data, predictions, alerts, and more. For example, an output 262 can include a graph showing the trend of electricity usage over time.

Output generator 260 can include any combination of hardware and software for generating outputs 262. Output generator 260 can generate outputs, such as responses to input queries 204 or instructions for implementing actions 266 responsive to input queries 204. Output generator 260 can be a component for generating outputs in response to input queries 204. Output generator 260 can execute the validated code and produce human-readable results, such as text, graphs, or audio, for presentation on the user interface application 282 on client device 280. For instance, output generator 260 can generate a report on monthly energy usage, a parameter providing electricity output, an electricity characteristic 210, or any other information or result. The generated outputs 262 can provide information and insights to the user.

The output generator 260 can be configured (e.g., via instructions and data stored in memory 415 for processing by a processor 410) to execute the processor-executable code 232 to generate output 262 responsive to the input query 204. The output generator 260 can operate with the code generator 230 or code validator 234 to validate the generated processor-executable code 232 based on a successful execution of the generated code in the framework environment 236. The output generator 260 can be configured to execute, responsive to the validation, the generated processor-executable code 232 on the grid edge device 201 to generate the output 262.

The output generator 260 can select, using ML (e.g., AI model 272), a format configured to render the output 262. The format can include at least one of natural language text, natural language speech, a graph, or an image. The output generator 260 can be configured to translate the output to the selected format. The output generator 260 can be configured to provide, to an output device of the grid edge device 201, the translated output 262.

Actions 266 can include any type and form of operations or commands executed by the data processing system 150 to manage and control electrical devices at a site. Actions 266 can include any actions for managing, operating, controlling, or adjusting a grid, or a component or a portion of a grid. Action 266 can include, for example, adjusting the settings of smart thermostats to change timing and set points for heating or cooling, turning on or off a DER, connecting to or disconnecting from another grid, such as a utility grid, or controlling the charging or discharging schedule of an energy storage device to minimize costs and reduce peak load. Actions 266 can involve managing the operation of various DERs such as solar panels and battery storage systems to maximize energy efficiency and reliability. For example, an action 266 can include automatically turning off unused devices (e.g., machines or lights), adjusting appliance usage based on time-of-use rates, or sending alerts to users about irregular energy consumption patterns. Such actions 266 can improve energy management and efficiency, reduce operational costs, or utilize the safe and optimal operation of the electrical grid.

Actions manager 264 can include any component for performing actions based on the outputs generated by the data processing system 150. Actions manager 264 can execute the validated code 232 to control devices, such as any components, systems, subsystems, or devices of a grid. Actions manager 264 can manage alerts or perform other tasks as specified by the user. For instance, actions manager 264 can turn off unused lights to save energy, activate energy from or to a DER, turn on or off access to a utility grid, measure or monitor electricity characteristics 210, or take any other action with respect to managing, controlling, adjusting operation of or otherwise utilizing a grid or a portion of a grid. The actions manager 264 can check or validate that the specified actions 266 are executed, implemented, or performed accurately or within particular predetermined parameters or metrics.

The actions manager 264 can be configured (e.g., via instructions and data stored in memory 415 for processing by a processor 410) to perform an action 266 in accordance with the output 262. Actions 266 can include any type and form of operations or commands executed by the data processing system 150 to manage and control electrical devices at a site. For example, if the output 262 indicates that the current energy consumption is exceeding the predefined limit, an action 266 can be performed by the actions manager 264 to reduce the power usage of unused or lower-priority devices. For example, if the output 262 includes a determination or prediction of a high electricity bill for the next month, an action 266 can be implemented to adjust the charging schedule of a device or a system to off-peak hours to save costs. For example, if the output 262 detects an anomaly in the energy usage pattern, an action 266 can be implemented to send an alert to a client device 280 to display (e.g., via a user interface) to investigate potential issues. The actions manager 264 can be configured to control a controllable device of the one or more controllable devices in accordance with at least one of the processor-executable code or the output.

The AI framework 270 can include any combination of one or more AI functionalities that can be used by the data processing system 150. The AI framework 270 can include AI models 272 for processing input queries, generating code, and optimizing outputs. For example, it can use ML algorithms or models trained to predict future energy consumption or usage. The AI framework 270 can incorporate natural language processing (NLP) models to understand and respond to user queries in a conversational manner. The AI framework 270 can include deep learning models for more complex data analysis and pattern recognition. The AI framework 270 can include generative adversarial networks (GANs) which can be used to create synthetic data for training purposes. The AI framework 270 can include reinforcement learning models to optimize the operation of controllable devices by learning from interactions with the environment. The AI framework 270 can include or utilize decision tree models for making rule-based decisions, as well as clustering algorithms to group similar data points to identify patterns in energy usage. The AI framework 270 can include anomaly detection models to identify irregularities in electricity consumption, facilitating detection of potential issues. The AI framework 270 can include time series analysis models to forecast future energy trends based on historical data. The AI framework 270 can include optimization algorithms to find the settings or setpoints for devices to achieve maximized energy efficiency or cost reduction. These diverse AI models and functionalities enable the data processing system 150 to provide accurate, relevant, and actionable insights to users.

AI models 272 can include any AI or ML model for generating prompts 214, generating code 232, providing outputs 262, or implementing and managing actions 266. AI models 272 can include any computational, AI, ML, or rule-based model used by the AI framework 270. AI models 272 can process input queries, generate code, and optimize outputs based on the data and constraints 216. For instance, AI models 272 can analyze historical data to provide insights into energy usage patterns. AI models 272 can use natural language processing (NLP) techniques to understand and respond to user input queries 204 in a conversational manner and provide outputs 262 comprising textual responses in the context of the input queries 204. AI models 272 can include deep learning models to provide complex data analysis and pattern recognition, or GANs to create synthetic data for training purposes. AI models 272 can include reinforcement learning models to optimize the operation of controllable devices by learning from interactions with the environment, decision tree models to make rule-based decisions, and clustering algorithms to group similar data points to identify patterns in energy usage. AI models 272 can include anomaly detection models to identify irregularities in electricity consumption, facilitate detection of potential issues, as well as time series analysis models to forecast future energy trends based on historical data. AI models 272 can include generative AI models to receive prompts 214 and data 242 as inputs to generate code 232 to implement various actions 266 or provide outputs 262. AI models 272 can include optimization algorithms to find the best solutions for energy management and cost reduction.

Client device 280 can be any device (e.g., a computer, a smartphone, a tablet, or a workstation) that can execute an application 282 to access or communicate with the interface application 202 of the data processing system 150. Client device 280 can include a device used by a user accessing a user interface of an application 282 to interact with the metering platform via the data processing system 150. The client devices 280 can include smartphones, tablets, and computers that run applications for generating input queries and receiving outputs. For instance, a user can use their smartphone to check their daily energy consumption and interact with the metering platform.

Application 282 can include any application 282 providing a user interface on a client device 280 for receiving input queries 204 (e.g., entered by users of the application 282) or providing outputs 262 (e.g., responses to the input queries). Application 282 can include a software application running on client devices 280. Application 282 can generate input queries for transmission to the data processing system 150 and display the outputs generated by the system. For example, an application 282 can show a user their projected electricity bill for the next month. The application 282 can enhance the user experience by providing an intuitive interface for interacting with the metering platform.

FIG. 3 is a block diagram of an example system 300 having various components of AI framework 270, which can also be referred to as the edge energy framework (EEF), in accordance with an implementation. The components of the example system 300 can be a part of a grid edge device 201 (e.g., a metering device 118) which can include or be in communication with (e.g., utilize) a data processing system 150. The components of the example system 300 can include at least the AI interface 270 (e.g., the EEF) and components in communication with the EEF, such as at least an interface application 202 (e.g., the NLI application), a local database (DB) 310, and DER interfaces 312. The components of the example system 300 can include an AI framework 270 (e.g., the EEF) having at least an NLM management 302 functionality for managing one or more NLMs (e.g., AI models 272), an outward interface 314, a local interface 318, and a knowledge inclusion, which can include knowledge update 330, knowledge base (KB) 324, local DB description 326 and DER description 328. In some cases, one or more components of the example system 300 can be external to the metering device 118 or the data processing system 150, such as features that can be executed on the cloud or a remote computing device. It should be noted that the AI framework 270 (e.g., the EEF) can include or be in communication with other components not limited to those discussed herein.

As shown, the components of the example system 300 can include the interface application 202 (e.g., an NLI application to provide an interface for a natural-language interaction). The NLI application can be installed or included on the client device (e.g., the phone, tablet, or computer) for interaction or communication with the AI framework 270 (e.g., the EEF). The NLI application can receive inputs from the users via at least one input device (e.g., keyboard, mouse, touchscreen, voice input, or gesture). The NLI application can present outputs or information discussed herein to the user via at least one output device (e.g., display device or audio device). The NLI application can communicate with the outward interface component of the EEF using natural language. The NLI application can be located at the site, e.g., residential home or entity with the metering platform. Types of input from the user can include, but are not limited, to questions, requests, commands, etc. For example, the user may input a question regarding electrical usage (e.g., daily or weekly usage, estimated electricity bill, etc.), a command to provide electrical usage information for loads at the site, etc. The inputs or queries from the user can be provided to the NLM management of the EEF via the outward interface.

The AI interface 270 (e.g., the EEF) can include the outward interface 314. The outward interface can include at least an input management component (e.g., sometimes referred to generally as an input manager 316 or input management 316) and a data privacy component (e.g., data privacy 317). The input management can receive the natural language requests from the NLI application to set up (e.g., by at least the NLM setup) the EEF for proper processing of the request. The data privacy component 317 can check and implement functionality to ensure that customer (or user) data is secure, e.g., share certain predefined types of data and prevent the sharing of certain other types of data. The types of data restricted from sharing can be predefined by the administrator of the system (e.g., the data processing system 150 or metering device 118) or by the user or consumer. The types of data allowed to be shared can be predefined by the administrator or the user.

The AI framework 270 (e.g., the EEF) can include one or more knowledge inclusion components. The knowledge inclusion components can provide at least KB functionalities, definitions (or descriptions) of the local DB, and the DER functionality, description, or definition to the NLM. The components (e.g., KB 324, local DB description 326, or DER description 328) of the knowledge inclusion components can provide the AI models 272 (e.g., the NLMs) with the information to support analyzing, monitoring, or controlling energy data and energy systems, e.g., via writing code and interpreting the results. For instance, the information for an AI model 272 (e.g., an NLM) can flow from the data sources (e.g., KB, local DB description, or DER description) into the NLM. The data sources can be updated or refined over time. For example, the knowledge inclusion component can include a knowledge update component configured to update at least one of the data sources. The knowledge update component can provide an update periodically, upon receiving broadcast updates from the cloud, in response to receiving an update request via the NLI application, etc.

The EEF can include the NLM management 302 component. The NLM management 302 can include one or more components (e.g., NLM setup component 304, NLM instruction 306 component, output adjustment 308 (e.g., output optimization component) for providing additional context, instructions, and execution of the AI model 272 (e.g., the NLM). The features of the NLM management 302 component can be executed or performed via a combination of providing additional inputs to the AI model 272 (e.g., the NLM) and utilizing one or more AI techniques to optimize the NLM output, such as a reflection for code improvement, agent planning and problem breakdown, or multiagent approaches. In various scenarios, interaction with the AI model 272 (e.g., the NLM) may include or involve one or more interactions or exchanges between the user and the NLM, for instance, to iteratively refine a request, refine the answer, or obtain more information.

For example, the NLM management 302 (e.g., NLM setup component) can provide specificity for the AI model 272 (e.g., the NLM), such as adding context to the request, conversation history (e.g., historical requests or inputs), or interpretation of the requests. In some cases, the NLM management (e.g., NLM setup component) may prompt the user for clarification of the request, command, or question via the NLI application. For instance, the NLM management 302 can process the query or request from the user to determine whether to request clarification or add context for setting up the NLM. The NLM management 302 can determine to request clarification if the query is unclear, e.g., if the question or command is unclear or whether the query is a question or command to be executed. In some cases, the NLM management 302 can communicate with the NLM to process the input query for determining to request clarification from the user. For instance, the KB 324 (or other data sources) may include information regarding supported types of actions (e.g., capable of being performed by the EEF), types of questions, etc. If the question or query from the user is not sufficiently specific or may be misinterpreted (e.g., interpreted in a plurality of ways), the NLM or the NLM management 302 can generate a question to request more context or clarification. The NLM management can receive feedback or clarification from the user to add context for the AI model 272 (e.g., the NLM) to process the query. The NLM management 302 can add context, such as information from the knowledge inclusion component, to enhance inputs to the NLM, thereby improving the output from the NLM.

The NLM management 302 can include an agent selector (not shown) for selecting a type of agent based on the user input or query. For example, the NLM management 302 (e.g., agent selector) can map the input or query from the user to a type of agent. The NLM management 302 can perform the mapping by at least one of identifying keywords (e.g., rule-based) in the query, asking or prompting the NLM to determine the type of request from the user (e.g., provide the query as an input and receive an indication of a type of agent to use as an output), or executing an ML classifier. The types of agents can be predefined, including at least one of, but not limited to, an analyzing agent (e.g., providing statistics, information, or insights from data), a managing or alerting agent (e.g., alerting when energy level is above a predefined threshold), or an action agent (e.g., charging electric vehicle (EV) to a predefined energy level by a predefined time). The agents of the AI model 272 (e.g., the NLM) can handle queries and controls of electrical devices authorized by the user.

The NLM management 302 (e.g., NLM instruction component) can issue or provide instructions to the NLM. The NLM management 302 can control the behavior or function of the NLM according to the query, e.g., processed by the NLM setup component. The NLM management 302 can control the function of the NLM according to the selected agent, such as to perform an analysis, manage alerts, or take actions on loads or DERs at the site. In some cases, the NLM management 302 (e.g., NLM instruction component) can indicate the knowledge (or data) source for the NLM to use. For example, the NLM management 302 can indicate to the NLM to use information from a particular knowledge source (e.g., background energy information). The NLM management 302 may provide information on the type of data collected at the site (or types of data collected by the edge devices) to the NLM. The NLM management 302 can provide the description of the devices (e.g., DERs) that the agent can control to the NLM, e.g., EV charger, power storage, thermostat, etc. The devices capable of being controlled by the EEF can be configured by the user via registration and authorization. The AI framework 27 (e.g., the EEF) can create instructions specific to the controllable DERs.

The output adjustment 308 of the NLM management 302 can refine or adapt the output from the NLM or other components of the EEF for clarification to the user. In some cases, the user may prompt the NLM to clarify the output via the NLI application. In such cases, the output adjustment 308 (e.g., the output optimization component) can allow for an ability to orchestrate the NLM (e.g., call the NLM more than once for a request) for clarification, thereby obtaining the desired output from the NLM. In some cases, the output adjustment 308 can evaluate the quality of the output, such as determining whether the output corresponds to the command issued by the user, the relevancy of the output to the query or request (e.g., requested information and type of information outputted), etc.

The EEF can include the local interface 318. The local interface 318 can provide programmatic interfaces into the local DB 310 and the DER interfaces 312. The local DB 310 can include, store, or maintain information collected or processed by the system (e.g., the metering device 118, the data processing system 150, or the metering platform). The DER interfaces 312 can allow for communication with the DERs. The AI model 272 (e.g., the NLM) can generate code 323 to access these functions. The code can be verified for correctness and security using at least one of the data security component or the device security component. The code can be executed to access the local DB, for example. The results from executing the code or accessing the local DB can be fed back to the NLM for inclusion in the natural language output.

In some configurations, the data security 322 component of the local interface 318 can verify that the local DB 310 is being accessed according to predefined security criteria or rules (e.g., staying within the rules). The device security 322 component can enforce the constraints or limits of devices on the site, such that commands or outputs to the controllable devices (e.g., DERs or loads) allow the devices to operate with the operational constraints (e.g., physical-based constraints on local voltage, regulated by the utility). The rules or constraints can be predefined by the administrator or utility operator. For example, the constraints can include voltage or current limits, maximum frequency for turning on or off the EV charger, predefined limit of devices to be controlled within a time period, etc.

In some cases, the AI model 272 (e.g., the NLM) can generate a code for the local interface, for instance, to access the local DB 310 or control devices, among other features or functionalities. The AI model 272 (e.g., the NLM) can utilize existing function calls or create new code to control one or more authorized devices (e.g., DERs or loads). The AI framework 270 (e.g., the EEF) or its device security 322 component can verify the code before execution. For example, the device security 322 component can put a synthetic device call to test the code execution or execute the generated code in a simulation before deployment. The device security 322 component can initiate a virtual environment to test the generated code before executing the code to control an actual device. The result of the simulation can be used as feedback for improving the code (e.g., to obtain different or improved results).

In some cases, code-generated (e.g., verified codes) by other metering devices 118 within the utility grid 100 can be uploaded to the cloud and downloaded by or shared with individual metering devices 118. In some other cases, the generated code or feedback to the code can be uploaded to the cloud for training or tuning a centralized NLM over time. The centralized NLM can be broadcasted or downloaded to the EEF of one or more metering devices 118, for example. The device security 322 component can bind one or more devices (e.g., DERs) to a predefined set of parameters for security purposes, depending on the utility parameters. In certain scenarios, such as when utilizing existing code or generating codes similar to existing codes, the device security component may determine to skip the simulation, thereby verifying the code for execution.

For verified codes, the local interface 318 can execute the function or code to access the local DB or control one or more DERs via the DER interfaces (e.g., edge solution). The output of executed function can be fed or sent back to the NLM. The AI model 272 (e.g., the NLM) can generate a result for presentation to the user, e.g., the result can include human-readable information, including texts, graphs, audio, statistics, etc. Examples of the results can include electricity consumption at a certain time period, prediction of electrical consumption, prediction of electric bill, an indication of completed (or failed) tasks, graphs showing information on the trend of electricity usage, etc. The format for presenting the results can be predefined or configured by the user. In some cases, the user can provide a query or input indicating the format to display the result or generated data.

In some arrangements, the metering platform can be in communication or connection with the user application (e.g., the NLI application) via a local Wi-Fi network controllable by the metering device 118. In such cases, certain information may not leave the site (e.g., not transmitted to the cloud). In combination with the local data storage, the metering platform can ensure minimal data leaves the local environment (e.g., the premises of the residential home), thereby protecting user privacy and information. The NLI application can be the interface for the natural language interaction with the user.

The systems and methods of the technical solution discussed herein can utilize the NLM to provide an accessible and robust way of accessing information to make decisions relevant to electricity use and the operation of flexible or controllable loads and DERs. The systems and methods can improve or protect privacy or data security by storing and processing data locally, which further minimizes data transmission rates. The systems and methods can be hardware-agnostic, allowing implementation of the features or functionalities discussed herein on various hardware, components, or metering devices 118, for example.

In some cases, the systems and methods can achieve the functionalities discussed herein by directly configuring the various inputs for the APIs of the hardware installed. In this case, the NLM can perform a similar specification-setting and aggregate the information (e.g., inputs for the APIs) in one place, alleviating the need for the user to aggregate the information. In some other cases, the systems and methods may use a cloud or remote database, additionally or alternatively to the local database.

Example questions for the natural language, electric-metering interface that the user may query can include at least one of, but not limited to, the following, which the systems and methods of the technical solution can aggregate this meta-information (e.g., electricity rate, efficiency of the appliances at the site, location of the site, relevant architectural features that apply to solar panels, current costs of DERs, or other information related to the electricity consumption or generation) with the electricity-usage data of the site to arrive at answers using the NLI. For reliability, the question may be, “Given the minimum set of appliances needed to survive in a power outage, what lengths of time could these appliances be run for a size range of home batteries?”

Examples of billing-type questions can include “what do you project my bill to be next month,” “how much low-level, always-on load do I have, and what are common sources of this,” or “are there any irregularities in my usage that I should look into? For example, one month being abnormally high, a certain day of the week always being high.” Examples of questions regarding the DERs can include, “if I bought an [EV type], how much would my electricity bill increase,” “if I bought an [EV type], would I need an electric-panel upgrade,” “what percentage of my overall energy usage is due to charging my EV,” “given my time-of-use (ToU) rate, how much money could I save if I shift my EV-charging times while still using the same amount of total energy to charge my EV,” or “given my ToU rate, how much money is my PV system saving me in a week.” Other types of query may include “send me a text every night at 11 if it seems like some device is left on that shouldn't be,” “I have to drive to [location] tomorrow at 8 am; please have my car charged to 80% with minimal cost or CO2 creation,” or “can I charge a second EV at home given the size of my electric panel.”

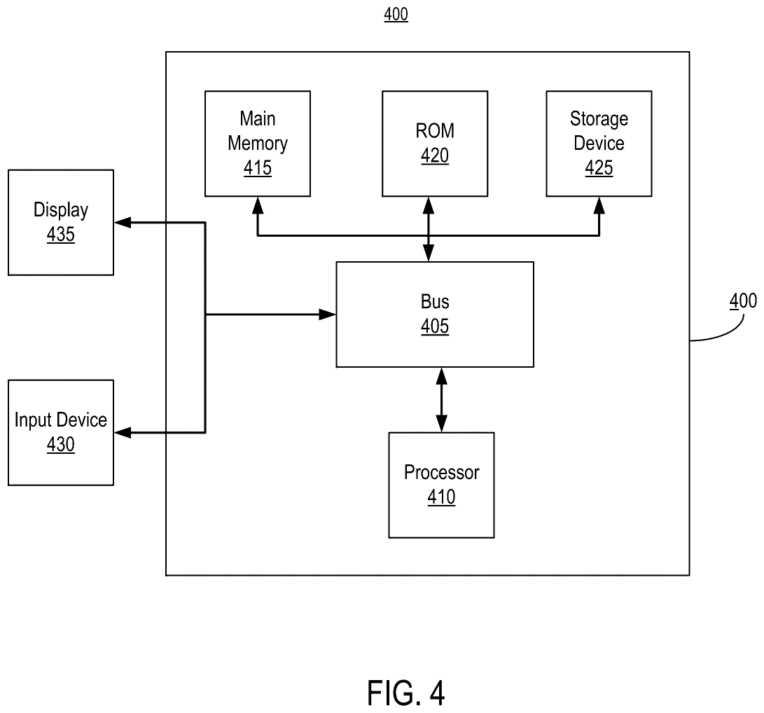

FIG. 4 is a block diagram of an example computer system 400. The computer system or computing device 400 can include or be used to implement the data processing system 150, or its components such as the data processing system 150. The computing system 400 includes at least one bus 405 or other communication components for communicating information and at least one processor 410 or processing circuit coupled to the bus 405 for processing information. The computing system 400 can also include one or more processors 410 or processing circuits coupled to the bus for processing information. The computing system 400 also includes at least one main memory 415, such as a random-access memory (RAM) or other dynamic storage devices, coupled to the bus 405 for storing information, and instructions to be executed by the processor 410. The main memory 415 can also be used for storing position information, utility grid data, command instructions, device status information, environmental information within or external to the utility grid, information on characteristics of electricity, or other information during execution of instructions by the processor 410. The computing system 400 may further include at least one-read only memory (ROM) 420 or other static storage device coupled to the bus 405 for storing static information and instructions for the processor 410. A storage device 425, such as a solid-state device, magnetic disk, or optical disk, can be coupled to the bus 305 to persistently store information and instructions.

The computing system 400 may be coupled via the bus 405 to a display 435, such as a liquid crystal display, or active matrix display, for displaying information to a user such as an administrator of the data processing system or the utility grid. An input device 430, such as a keyboard or voice interface may be coupled to the bus 405 for communicating information and commands to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435. The display 435 can be part of the data processing system 150, or other components of FIG. 1 or FIG. 2.

The processes, systems, and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter, including the operations described in this specification, can be implemented in other types of digital electronic circuitry, or in computer software, firmware, or hardware, including the structures disclosed in this specification and their structural equivalents, or in combinations of one or more of them.

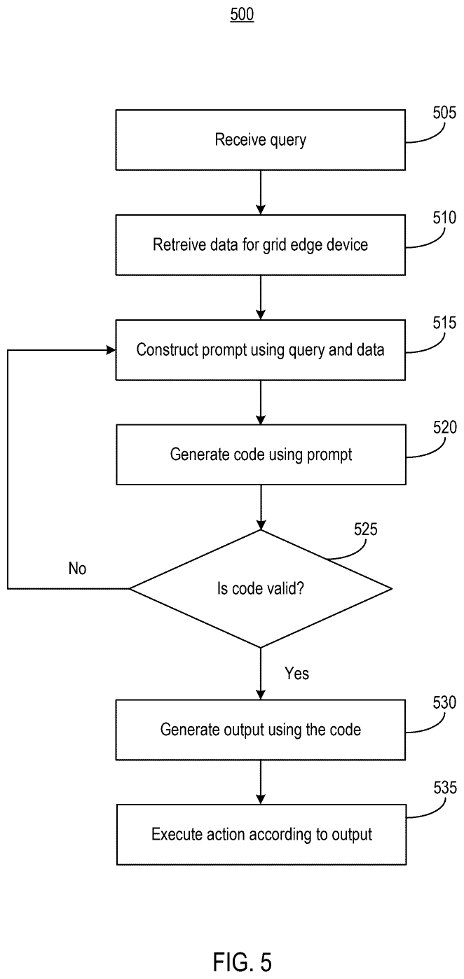

FIG. 5 illustrates an example of a flow diagram of an example method 500 for interacting with an electric metering platform. Example method 500 can be executed by a data processing system of a grid edge device, which can be implemented, for example, using one or more processors (e.g., 410) of the grid edge device executing instructions and data stored in memory (e.g., 415) of the grid edge device. The method 500 can be implemented using any combination of any features and functionalities described in connection with FIGS. 1-4 implementing acts 505-535. At act 505, the method can receive a query. At act 510, the method can retrieve data for a grid edge device. At act 515, the method can construct a prompt using the query and the data. At act 520, the method can generate a code using the prompt. At act 525, the method can determine if the code is valid. At act 530, the method can generate output using the code. At act 535, the method can execute an action according to the output.

At 505, the method can receive a query. The method can include the one or more processors coupled with memory receiving, via an interface of the grid edge device, an input query related to a characteristic of electricity (e.g., an electricity characteristic) at a site. The site can be a site located at an edge of an electric distribution grid at which the grid edge device is deployed, located, or operating. The grid edge device can include, access, communicate with, or utilize a data processing system. The data processing system can be implemented on the one or more processors using instructions and data from one or more memories. The input query can be received from a client device via a network. The input query can include a string of characters indicative of a request of an action or an output by the data processing system or the grid edge device.

The method can include the one or more processors classifying the input query as a first type of a plurality of types. The method can include the one or more processors selecting an agent from a plurality of different types of agents configured with the one or more generative artificial techniques. The method can include classifying the first type of the plurality of types of agents. For instance, an agent can be an analyst agent for analyzing the operation of a grid or a device on a grid. For instance, an agent can be a monitoring agent for monitoring electricity or electricity characteristics on a grid or a portion of a grid. For example, an agent can be an action agent to implement or execute one or more actions, such as adjustments of settings or setpoints of devices on a grid, adjustment of smart thermostats, controlling or setting the charging or discharging timing or schedules for DERs, starting or stopping of usage of utility grid electricity, or any other action that can be implemented on a grid system.

At 510, the method can retrieve data for a grid edge device. The method can include the one or more processors retrieving from memory, such as a database of a storage device, data for the grid edge device. The data for the grid edge device can be data specific to, configured for, or associated with a particular grid edge device of a plurality of grid edge devices. The data can include contextual data or information for the site at which the grid edge device is located. The data can include operational data from one or more controllable devices located at the site. The data can include metering data (also referred to as the metering signal data set) that can be generated via signal processing on electrical metering signals related to the site. The data can include any combination of the contextual data, the operational data, or the metering data for the grid edge device. The method can include authenticating a provider of the input query and granting access to retrieve the data for the grid edge device responsive to such authentication.

At 515, the method can construct a prompt using the query and the data. The method can include the one or more processors constructing a prompt data structure. The method can include the prompt generator constructing or generating the prompt (e.g., prompt data structure) using one or more generative AI techniques, such as an AI model trained to generate the prompt based on the input query and the data for the grid edge device input into the AI model. The AI model can be trained to generate the prompt data structure, including any instructions, descriptions, or data (e.g., parameters) for a prompt to instruct, guide, direct, or otherwise manage the AI model to generate the prompt based on the data (e.g., contextual data, operational data, and metering data) input into the AI model.

The method can include the one or more processors identifying a boundary constraint for the grid edge device based on the data. The method can include constructing or generating the prompt data structure to include an indication of the boundary constraint. The boundary constraint can be a physics-based constraint for the grid edge device, such as a maximum or a minimum allowable voltage, current or power level for operating a system, a current limit for an electrical device, a temperature, voltage, current, or power threshold or set point for operating a device, or a frequency or phase constraint or threshold for an electrical grid or a device on the grid.

The method can include the one or more processors requesting, subsequent to receipt of the input query, information to construct the prompt data structure. The method can include constructing the prompt data structure based on further information received responsive to the request. The method can include iteratively updating the prompt data structure based on one or more additional requests for information. The method can include the one or more processors storing, in a local knowledge base on the edge device, the information received responsive to the one or more additional requests.

At 520, the method can generate a code using the prompt. The method can include the one or more processors generating a processor-executable code. The one or more processors can generate the code responsive to the prompt data structure and use the one or more generative AI techniques on the grid edge device. The method can include a code generator utilizing one or more AI models to generate the code based on the prompt, or the one or more constraints for one or more parameters of the prompt, input into the AI model. The code can include one or more instructions or commands, parameter values or ranges, operational characteristics, and setpoints for one or more devices or for one or more operations to be executed or implemented on the grid system.

At 525, the method can determine if the code is valid. The method can include the one or more processors validating the processor-executable code in a framework environment of a grid edge device. The method can include a code validator of a code generator implementing one or more validation tests to verify or validate the code generated by the code generator. The code generator or the code validator can determine to validate the generated processor-executable code prior to execution on the grid edge device. For instance, the code validator can execute, responsive to the determination, the generated processor-executable code in a framework environment on the grid edge device. The code validator can validate the generated processor-executable code based on a successful execution of the generated code in the framework environment. For instance, the code validator can include one or more input and output pairs where one or more inputs can be input into the code and outputs from the code can be compared against the predetermined outputs from the input and output pairs. If the outputs from the code match the predetermined outputs, the code validator can determine that the code operates correctly and therefore determine that the code is valid.

The code validator can validate the code or determine to perform the validation of the processor-executable code based on one or more actions or operations. For example, the code validator can validate the code or determine to perform the validation of the code based on a comparison of the processor-executable code with historically executed code stored in memory. For example, the code validator can validate the code or determine to perform the validation of the code based on an evaluation of the processor-executable code using one or more rules prior to the execution of the processor-executable code. For example, the code validator can validate the code or determine to perform the validation of the code based on a determination of a performance of the processor-executable code during the execution of the processor-executable code. For example, the code validator can validate the code or determine to perform the validation of the code based on an evaluation of the processor-executable code using the one or more generative AI techniques. For example, the code validator can validate the code or determine to perform the validation of the code based on a simulation of an execution of the processor-executable code. For example, the code validator can determine to perform the validation of the processor-executable code based on the severity of a boundary constraint of the grid edge device.

In some implementations, the determination of whether the code is valid can determine the next action of the method. For instance, in some implementations, if the code is not validated (e.g., not determined to be valid or determined to be invalid) at act 525, the method can move to act 515 to construct a new or updated prompt using an adjusted query, an adjusted data or an adjusted instruction with the query and data. For instance, in some implementations, if the code is validated (e.g., determined to be valid) at act 525, the method can move to act 530 to generate the output using the validated code.

At 530, the method can generate output using the code. The one or more processors can execute the processor-executable code to generate output responsive to the input query. For example, the one or more processors can implement, execute, or produce an output using the processor-executed code, such as the code validated at 525. The output can include a determination made to take an action or implement an operation on the grid-based system. The output can include a determination to stop an operation of a device due to an electrical limit being reached or exceeded, a detection of an anomaly of a system to trigger a corrective action to protect a device or the system, or a determination to switch from utility grid usage to usage of energy stored in one or more DERs.

The method can include the one or more processors selecting an agent from a plurality of different types of agents configured with the one or more generative artificial techniques and generating the processor-executable code using the selected agent. The method can include constructing the prompt data structure to include an indication of the boundary constraint and generating the output in accordance with the boundary constraint. For instance, the output can include a determination to stop operation of a device when a particular threshold power, voltage, or current is satisfied.

The method can include the one or more processors validating the generated processor-executable code based on a successful execution of the generated code in the framework environment. The method can include the one or more processors executing, responsive to the validation, the generated processor-executable code on the grid edge device to generate the output. The method can include the one or more processors selecting, using ML, a format configured to render the output, wherein the format comprises at least one of natural language text, natural language speech, a graph, or an image. The method can include translating the output to the selected format and providing, to an output device of the grid edge device, the translated output.

At 535, the method can execute an action according to the output. The method can include performing an action in accordance with the output. The method can include controlling a controllable device of the one or more controllable devices in accordance with at least one of the processor-executable code or the output. The method can include, for example, turning off or turning on a device on the grid, in response to the output. The method can include, for example, turning on charging or discharging of energy of a DER, responsive to the output. The method can include, for example, activating or deactivating usage of a utility grid, responsive to the output.

Some of the descriptions herein emphasize the structural independence of the aspects of the system components (e.g., arbitration component) and illustrate one grouping of operations and responsibilities of these system components. Other groupings that execute similar overall operations are understood to be within the scope of the present application. Modules can be implemented in hardware or as computer instructions on a non-transient computer-readable storage medium, and modules can be distributed across various hardware- or computer-based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a compact disc read-only memory (CD-ROM), a flash memory card, a programmable read-only memory (PROM), a RAM, a read-only memory (ROM), or a magnetic tape. In general, the computer-readable programs can be implemented in any programming language, such as List processing (LISP), practical extraction and reporting language (PERL), C, C++, C#, programmation en logique (PROLOG), or in any bytecode language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices, including cloud storage). The operations described in this specification can be implemented as operations performed by a data processing apparatus on data stored on one or more computer-readable storage devices or received from other sources.

The terms “computing device,” “component,” or “data processing apparatus,” or the like, encompass various apparatuses, devices, and machines for processing data, including by way of example a programmable processor, a computer, a system on a chip, or multiple ones, or combinations of the foregoing. The apparatus can include special purpose logic circuitry, e.g., a field programmable gate array (FPGA) or an application specific integrated circuit (ASIC). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC. Devices suitable for storing computer program instructions and data can include non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disk read-only memory (CD-ROM) and digital versatile disk read-only memory (DVD-ROM) disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a GUI or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations.

The phraseology and terminology used herein are for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation or embodiment, and references to “an implementation,” “some implementations,” “one implementation,” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed descriptions, or any claims are followed by reference signs, the reference signs have been included to increase the intelligibility of the drawings, detailed descriptions, and claims. Accordingly, neither the reference signs nor their absence have any limiting effect on the scope of any claim elements.

Modifications of described elements and acts such as variations in sizes, dimensions, structures, shapes, and proportions of the various elements, values of parameters, mounting arrangements, use of materials, colors, and orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system to interact with an electric metering platform, comprising:
a grid edge device comprising one or more processors, coupled with memory, to:
receive, via an interface of the grid edge device, an input query related to a characteristic of electricity at a site located at an edge of an electric distribution grid;
retrieve, from memory, data for the grid edge device comprising: i) contextual information for the site at which the grid edge device is located, ii) operational data from one or more controllable devices located at the site, and iii) a metering signal data set generated via signal processing on electrical metering signals related to the site;
construct a prompt data structure using one or more generative artificial intelligence techniques based on the input query and the data for the grid edge device;
generate, using the one or more generative artificial intelligence techniques on the grid edge device, processor-executable code responsive to the prompt data structure;
execute the processor-executable code to generate output responsive to the input query; and
perform an action in accordance with the output.

2. The system of claim 1, comprising the one or more processors to:
classify the input query as a first type of a plurality of types;
select an agent from a plurality of different types of agents configured with the one or more generative artificial techniques; and
generate the processor-executable code using the selected agent.

3. The system of claim 2, comprising the one or more processors to:
classify the first type of the plurality of types of agents, wherein the plurality of types of agent comprise at least one of an analyst agent, a monitoring agent, or an action agent.

4. The system of claim 1, comprising the one or more processors to:
authenticate a provider of the input query; and
grant access to retrieve the data for the grid edge device responsive to the authentication.

5. The system of claim 1, comprising the one or more processors to:
identify a boundary constraint for the grid edge device based on the data;
construct the prompt data structure to include an indication of the boundary constraint; and
generate the output in accordance with the boundary constraint.

6. The system of claim 5, wherein the boundary constraint is a physics-based constraint for the grid edge device.

7. The system of claim 1, comprising the one or more processors to:
determine to validate the generated processor-executable code prior to execution on the grid edge device;
execute, responsive to the determination, the generated processor-executable code in a framework environment on the grid edge device;
validate the generated processor-executable code based on a successful execution of the generated code in the framework environment;
execute, responsive to the validation, the generated processor-executable code on the grid edge device to generate the output.

8. The system of claim 7, comprising the one or more processors to:
determine to perform the validation of the processor-executable code based on at least one of:
a comparison of the processor-executable code with historically executed code stored in memory;
an evaluation of the processor-executable code using one or more rules prior to the execution of the processor-executable code;
determination of a performance of the processor-executable code during the execution of the processor-executable code;
evaluation of the processor-executable code using the one or more generative artificial intelligence techniques; or
a simulation of an execution of the processor-executable code.

9. The system of claim 7, comprising the one or more processors to:
determine to perform the validation of the processor-executable code based on a severity of a boundary constraint of the grid edge device.

10. The system of claim 1, wherein to perform the action, the one or more processors are further configured to:
select, using machine learning, a format configured to render the output, wherein the format comprises at least one of natural language text, natural language speech, graph, or an image;
translate the output to the selected format; and
provide, to an output device of the grid edge device, the translated output.

11. The system of claim 1, wherein to perform the action, the one or more processors are further configured to:
control a controllable device of the one or more controllable devices in accordance with at least one of the processor-executable code or the output.

12. The system of claim 1, comprising the one or more processors to:
request, subsequent to receipt of the input query, information to construct the prompt data structure; and
construct the prompt data structure based on further information received responsive to the request.

13. The system of claim 12, comprising the one or more processors to:
iteratively update the prompt data structure based on one or more additional requests for information; and
store, in a local knowledge base on the edge device, the information received responsive to the one or more additional requests.

14. A method of interacting with an electric metering platform, comprising:
receiving, by a grid edge device comprising one or more processors, coupled with memory, via an interface of the grid edge device, an input query related to a characteristic of electricity at a site located at an edge of an electric distribution grid;
retrieving, by the grid edge device, from memory, data for the grid edge device comprising: i) contextual information for the site at which the grid edge device is located, ii) operational data from one or more controllable devices located at the site, and iii) a metering signal data set generated via signal processing on electrical metering signals related to the site;
constructing, by the grid edge device, using one or more generative artificial intelligence techniques, a prompt data structure based on the input query and the data for the grid edge device;
generating, by the grid edge device, using the one or more generative artificial intelligence techniques on the grid edge device, processor-executable code responsive to the prompt data structure;
executing, by the grid edge device, the processor-executable code to generate output responsive to the input query; and
performing, by the grid edge device, an action in accordance with the output.

15. The method of claim 14, comprising:
classifying, by the grid edge device, the input query as a first type of a plurality of types;
selecting, by the grid edge device, an agent from a plurality of different types of agents configured with the one or more generative artificial techniques; and
generating, by the grid edge device, the processor-executable code using the selected agent.

16. The method of claim 14, comprising:
authenticating, by the grid edge device, a provider of the input query; and
granting, by the grid edge device, access to retrieve the data for the grid edge device responsive to the authentication.

17. The method of claim 14, comprising:
identifying, by the grid edge device, a boundary constraint for the grid edge device based on the data;
constructing, by grid edge device, the prompt data structure to include an indication of the boundary constraint; and
generating, by the grid edge device, the output in accordance with the boundary constraint.

18. The method of claim 14, comprising:
determining, by the grid edge device, to validate the generated processor-executable code prior to execution on the grid edge device;
executing, by the grid edge device, responsive to the determination, the generated processor-executable code in a framework environment on the grid edge device;
validating, by the grid edge device, the generated processor-executable code based on a successful execution of the generated code in the framework environment;
executing, by the grid edge device, responsive to the validation, the generated processor-executable code on the grid edge device to generate the output.

19. A non-transitory computer-readable medium storing processor-executable instructions that, when executed by one or more processors, cause the one or more processors to:
receive, via an interface of a grid edge device, an input query related to a characteristic of electricity at a site located at an edge of an electric distribution grid;
retrieve, from memory, data for the grid edge device comprising: i) contextual information for the site at which the grid edge device is located, ii) operational data from one or more controllable devices located at the site, and iii) a metering signal data set generated via signal processing on electrical metering signals related to the site;
construct a prompt data structure using one or more generative artificial intelligence techniques based on the input query and the data for the grid edge device;
generate, using the one or more generative artificial intelligence technique on the grid edge device, processor-executable code responsive to the prompt data structure;
execute the processor-executable code to generate output responsive to the input query; and
perform an action in accordance with the output.

20. The non-transitory computer-readable medium of claim 19, wherein the instructions further include instructions to:
classify the input query as a first type of a plurality of types;
select an agent from a plurality of different types of agents configured with the one or more generative artificial techniques; and
generate the processor-executable code using the selected agent.
